(19) United States
(12) Patent Application Publication
(10) Pub. No.: US 2009/0282362 A1
(43) Pub. Date: Nov. 12, 2009

(54) GRAPHIC SYSTEM DISPLAYING SCROLL BAR

(75) Inventor: Kentaro Matsumoto, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/435,486

(22) Filed: May 5, 2009

(30) Foreign Application Priority Data
May 7, 2008 (JP) 2008-121090

(51) Int. Cl. G06F 3/048

(52) U.S. Cl. 715/787; 715/834

(57) ABSTRACT

A graphic system has a first display processor and a second display processor. The first display processor displays a first scroll bar on a screen. In the first scroll bar, a first scroll knob is provided and a scale, which is associated with information displayed on the screen, is provided. The graphic system further has a scroll controller that scrolls the information in accordance with the movement of the first scroll knob. When a given operation is carried out during the display of the first scroll bar, the second display processor displays a partial range of the first scroll bar as a second scroll bar. In the partial range, a first scroll knob is included. Then, the second display processor defines the scale of the second scroll bar as the scale of the partial range. The scroll controller scrolls the information in accordance with an operation performed on the second scroll bar.

### BACKGROUND OF THE INVENTION

1. Field of the Invention

The present invention relates to a graphic system with scrolling function that carries out signal processes to display information such as an image or text on a screen and that is capable of scrolling the displayed information. In particular, it relates to the display of a scroll bar.

2. Description of the Related Art

In software used in the computer field, such as word processing software, spread-sheet software, video editing software, etc., the operating environment is designed such that information displayed on a screen can be scrolled. While information such as a document or an image is displayed on a monitor, a scroll bar is ordinarily displayed. In the scroll bar, a scroll knob is arranged and arrow buttons are displayed at either end of the scroll bar. The information is scrolled by dragging the scroll knob or clicking the arrow buttons. In some cases, a calibrated or graduated scroll bar is displayed. For example, when replaying a movie, replay time is graduated along the scroll bar.

The extent of a scroll operation depends upon the signal-processing performance in updating the screen contents and the performance of the input device in use (such as a mouse), and it is difficult to scroll the displayed information finely or very quickly. To allow the information to be scrolled finely, for example, a scroll box compactly containing a scroll knob and a pair of arrow buttons is displayed in the scroll bar. However, the length of a unit of the scroll on the screen, namely, the minimum amount of scroll, does not change compared with a non-scroll box. Scrolling the information finely is difficult for the user even if the scroll box is used. Therefore, for example, an image cannot be scrolled or exchanged finely in an image edit.

### SUMMARY OF THE INVENTION

An object of the present invention is to provide a graphic system such as a computer and apparatus/method for controlling a scroll bar display that is capable of allowing the user to scroll information finely and with facility.

A graphic system according to one aspect of the present invention provides a first display processor and a second display processor. The first display processor displays a first scroll bar, i.e., carries out a signal process to display a scroll bar on the screen. In the first scroll bar, a first scroll knob is provided and a scale, which is associated with information displayed on the screen (window contents), is provided. The graphic system further provides a scroll controller that scrolls the information in accordance with the movement of the first scroll knob.

In the present invention, when a given operation is carried out while the first scroll bar is displayed, the second display processor displays a partial range of the first scroll bar as a second scroll bar. In the partial range, the display area of the first scroll knob is included. Then, the second display processor sets the partial range as the scale of the second scroll bar. The scroll controller scrolls the information in accordance with the operation performed on the second scroll bar.

The second scroll bar with a scale different from the first allows the user to adjust the amount of scroll in a specific scale range in the first scroll bar, and scale units may be displayed clearly since the second scroll bar may be displayed freely. For example, the second display processor may display the second scroll bar so as to be longer than the length of the partial range. Therefore, the information displayed on the screen may be scrolled finely within a desired range of the first scroll bar through a simple operation.

For example, the first display processor displays graduations in accordance with the scale of the first scroll bar, and the second display processor displays graduations in accordance with the scale of the second scroll bar. In the case of image editing software, a motion picture may be displayed while the first scroll bar is displayed, and a still image may be displayed when the second scroll bar is displayed.

As another example, the first and second scroll bars may be displayed simultaneously. The first display processor may shift a position of the first scroll knob in accordance with a scroll performed on the second scroll bar.

The second display processor may display a second scroll knob in the second scroll bar. The scroll controller scrolls the information in accordance with the movement of the second scroll knob. Also, the second display processor may change the scale of the second scroll bar in accordance with an operation performed on the second scroll bar. Furthermore, the second display processor changes scale when an operation of the second scroll knob along a direction perpendicular to the longitudinal direction of second scroll bar is performed.

The second display processor pivots the second scroll bar in accordance with a given operation. The scroll controller scrolls the information in accordance with the distance from a pivot axis to the operation position. The second display processor may display a radial indicator that comprises a series of lines extending radially and has a scale from a center point up to the ends of the lines.

An apparatus for controlling a display of a scroll bar according to another aspect of the present invention provides a display processor that displays a second scroll bar when an input operation is performed in a state that a first scroll bar that comprises a scale associated with information displayed on a screen is displayed. The display processor displays the second scroll bar so as to be longer than the first scroll bar. The apparatus further provides a scale controller that defines the scale of a partial range of the first scroll bar as the scale of the second scroll bar.

A computer-readable medium that stores a program for controlling a display of a scroll bar provides a display process code segment that displays a second scroll bar when an input operation is performed in a state that a first scroll bar that comprises a scale associated with information displayed on the screen is displayed. The display process code segment displays the second scroll bar so as to be longer than the first scroll bar; and

a scale control code segment that defines a scale of a partial range of the first scroll bar as a scale of the second scroll bar.

A method for controlling the display of a scroll bar according to another aspect of the present invention includes: a.) displaying a second scroll bar when an input operation is performed in a state that a first scroll bar that comprises a scale associated with information displayed on the screen is displayed; b.) displaying the second scroll bar so as to be longer than the first scroll bar; and c.) defining the scale of a partial range of the first scroll bar as the scale of the second scroll bar.

### BRIEF DESCRIPTION OF THE DRAWINGS

The present invention will be better understood from the description of the preferred embodiments of the invention set forth below together with the accompanying drawings, in which:

FIG. 1 is a block diagram of a computer system according to the first embodiment;

FIG. 2 illustrates the screen when image editing software starts up;

FIG. 3 illustrates a magnified display of the normal scroll bar;

FIG. 4 illustrates a change of scale in the magnification scroll bar N;

FIG. 5 illustrates a changed end times of scale of the magnification scroll bar N;

FIG. 6 is a flowchart of a scroll control process;

FIG. 7 illustrates a screen displaying a scroll bar according to the second embodiment;

FIG. 8 illustrates a screen displaying a scroll bar according to the third embodiment;

FIG. 9 illustrates a display of a scroll bar according to the fourth embodiment; and

FIG. 10 illustrates a display of the scale-changed scroll bar.

### DESCRIPTION OF THE PREFERRED EMBODIMENTS

Hereinafter, the preferred embodiments of the present invention are described with reference to the attached drawings.

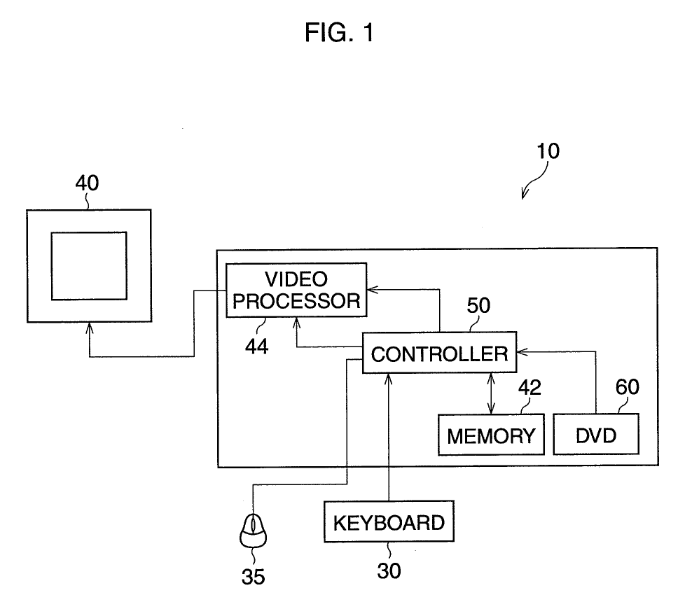

FIG. 1 is a block diagram of a computer system according to the first embodiment.

In FIG. 1, a computer system is equipped with a computer 10, and a keyboard 30. A mouse 35 and a monitor 40 are connected to the computer 10. Also, a DVD 60 is removably installed in the computer 10. A video processor 44 processes image signals and/or character signals to display an image and/or characters on the monitor 40. A controller 35 controls the action of the computer 10. A computer program associated with a control of the computer 10 is stored in a memory 42 such as a ROM unit. Also, application software, such as word-processing software, spread-sheet software, image editing software, etc., is stored in the memory 42.

When the image editing software starts up, image data is read from the DVD 60 and fed to the video processor 44. In the video processor 44, image data is subjected to processes so as to display images and character information such as icons on the monitor 40.

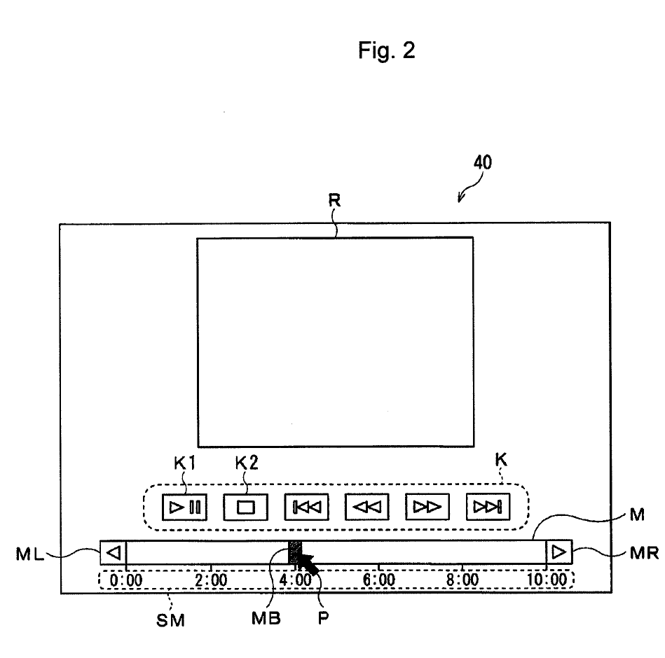

Hereinafter, the display of a scroll is explained with FIGS. 2 to 5. The scrolling operation of the image editing software is explained.

FIG. 2 illustrates a screen when image editing software starts up. When the user selects a movie file from a series of movie files, a movie of the selected file is replayed within frame R on the screen. Also, a series of control buttons K, including an icon K1 and a pause button K2, is displayed and a scroll bar (hereinafter, called “the normal scroll bar”) M is displayed on the screen.

Two buttons (hereinafter, called “right and left buttons”) MR and ML are displayed at either end of the normal scroll bar M, and a scroll knob MB is displayed between the right and left buttons MR and ML. The scroll knob MB is capable of moving between the right and left buttons MR and ML in accordance with the user's input.

The normal scroll bar M has a scale SM, which is defined by graduating an interval of replay time selected in the normal scroll bar M, into equal time intervals, and is displayed alongside the scroll bar M while matching the display range of the scale with the length of the normal scroll bar M. Herein, the whole of replay time is set to 10 hours, and graduations are displayed at 2 hour intervals.

When scrolling the moving image, the user clicks the mouse 35 while positioning a pointer P on the replay/pause button K1 to pause the movie temporarily. Then, the user puts the pointer P on the scroll knob MB using mouse 35, and shifts the scroll knob MB toward the right and left by dragging the scroll knob MB.

When the user drops the scroll knob MB and clicks the replay/pause button K1, a movie, which is scrolled by a period corresponding to an amount of a movement of the scroll knob MB, is replayed. Note that, the user can also scroll the movie while replaying the movie.

Note that signal processes for displaying the normal scroll bar M and for scrolling the displayed image are performed in the computer 10 by processes well known to a person skilled in the art.

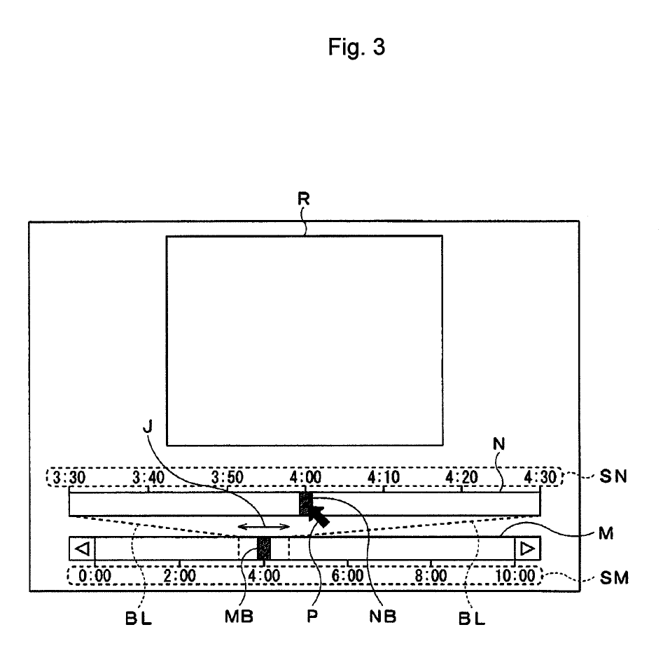

FIG. 3 illustrates a magnification display of the normal scroll bar.

When the user clicks the scroll knob MB such that the display of the movie pauses and moves the pointer P on the scroll knob MB upwards, i.e., in a direction perpendicular to the normal scroll bar M, the series of control buttons are erased, and a different scroll bar N, (hereafter, called a “magnification scroll bar”), is displayed alongside the normal scroll bar M. The length of the magnification scroll bar N is the same as that of the normal scroll bar M.

The magnification scroll bar N subdivides the scale of the normal scroll bar M and adopts a partial range J of the normal scroll bar M in the magnification scroll bar N. The partial range J contains a display area of the scroll knob MB, and has an area that is symmetrical with respect to the scroll knob MB. The whole of a scale of the magnification scroll bar N corresponds to that of the partial range J. Herein, the magnification factor is set to 10, and thus, the scale of the partial range J, “a period of one hour” is defined as the whole scale of the magnification scroll bar N. Then, a graduation in 10 minute increments is set.

In FIG. 3, the scroll knob MB is located at “4:00”, and the partial range J from a time “3:30” to a time “4:30” is set to the scale of the magnification scroll bar N. The time “3:30” and the time “4:30” are displayed at opposite ends of the magnification scroll bar N, and a time series graduated at ten-minute intervals within the range from “3:30” to “4:30”, is set.

Also, broken lines BL, connecting the ends of the partial range J and the ends of the magnification scroll bar N, are displayed on the screen. Thus, the user can confirm what range in the normal scroll bar M is magnified, i.e., what range can be scrolled.

While the magnification scroll bar N is displayed, a still image corresponding to a position of the scroll knob NB is displayed within the frame R. The displayed still image is replaced with a still image before or after the displayed image as the user shifts the scroll knob NB in a right or left direction.

Furthermore, when the user moves the pointer P upwards, namely, moves the mouse 35 upwards while dragging the scroll knob NB, the magnification factor increases and the scale of the magnification scroll bar N changes, as described below.

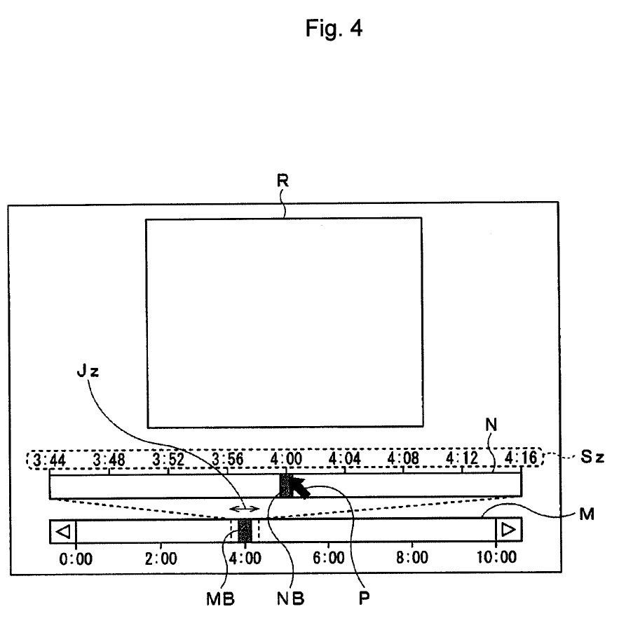

FIG. 4 illustrates a change of scale in the magnification scroll bar N. When the pointer P moves upwards on the scroll knob NB by a distance longer than a predetermined distance, the scale of the magnification scroll bar N is changed to scale Sz in accordance with the amount of movement of the pointer P, and a series of changed times are graduated into the magnification scroll bar N on the basis of the newly defined scale Sz Also, the scale of the partial range of the normal scroll bar M is changed to a new scale Jz in accordance with the scale Sz.

In FIG. 4, the scale of one hour is changed to the scale Jz of thirty two minutes, and graduations based on the scale Sz are displayed along the magnification scroll bar N. Herein, time “3:44” and time “4:16” are displayed at the ends of the magnification scroll bar N, and a series of times graduated at four minute intervals is set.

Furthermore, when the scroll knob NB moves to the end position (in FIG. 4, the time “3:44” or the time “4:16”), by dragging the scroll knob NB, the scale Sz of the magnification scroll bar N is changed as explained below.

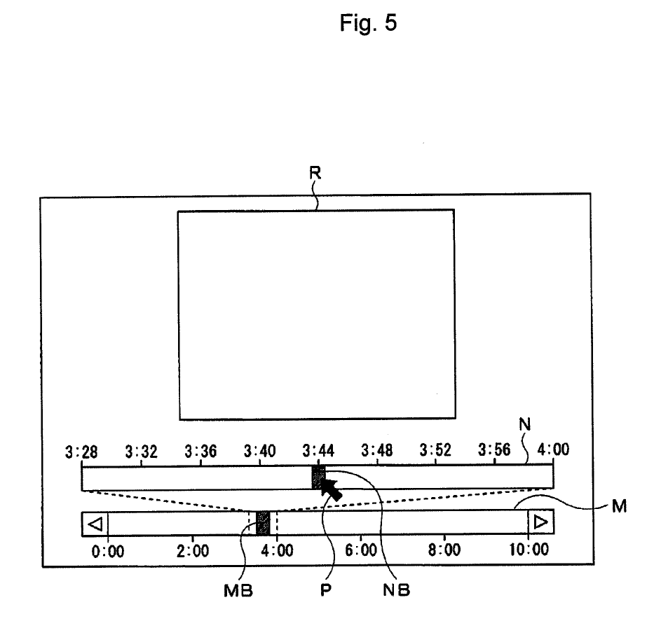

FIG. 5 illustrates a change of scale of the magnification scroll bar N. As shown in FIG. 5, when the scroll knob NB reaches the left end of the magnification scroll bar B, the scroll knob NB moves to the center of the magnification scroll bar N, and the time of the left end (in FIG. 4, the time “3:44”) is set to a center of the scale Sz. Then, the times “3:28” and “4:00” are displayed at the ends of the magnification scroll bar N.

One could say, the time at the left or right end shown in FIG. 4 is set to the center time of the magnification scroll bar N, and the scale range is changed in accordance with the newly positioned center time, namely, changed from the range between the time “3:44” and the time “4:16” to the range between “3:28” and the time “4:00”. Similarly, when the scroll knob NB moves to the right end of the magnification scroll bar N (herein, time “4:16”), the time of the right end is set to the center time of the magnification scroll bar N, and the scale range is changed.

The scroll knob MB in the normal scroll bar M also moves in accordance with the change of the scale. Then, the broken lines BL are changed in accordance with the movement of the scroll knob MB.

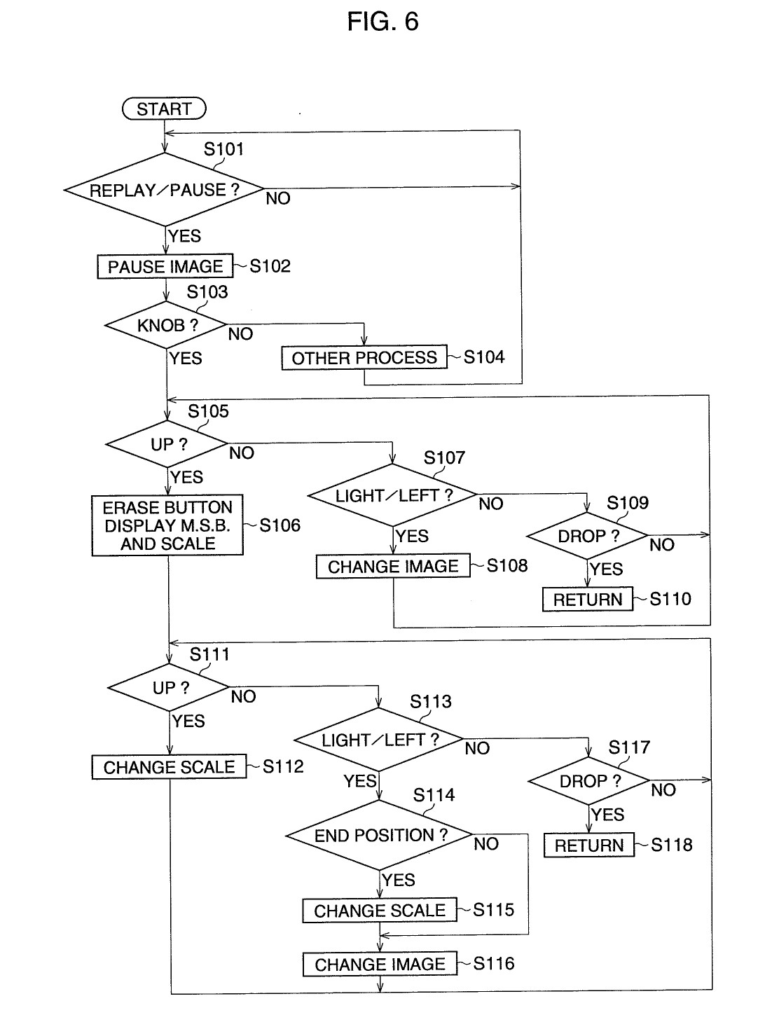

FIG. 6 is a flowchart of a scroll control process.

When the user clicks the replay/pause button K1 while displaying a movie (S101), the display of the movie pauses, and a still image corresponding to the time designated by the scroll knob MB is displayed within the frame R (S102). Then, it is determined whether the drag has been performed to move pointer P on the scroll knob MB.

If it is determined that the drag has not been performed, other process is performed (S104). On the other hand, when it is determined that the drag has been performed, it is determined whether the user has moved the pointer P upwards, namely, the mouse 35 moves upwards while the scroll knob MB is dragged(S105).

If it is determined that the user has not moved the pointer P upwards, it is then determined whether the user has moved the pointer P in the right or left direction (S107). If it is determined that the user has moved the pointer P either left or right, the still image displayed within the frame R is changed to a different still image corresponding to the position of the moved scroll knob MB (S108). Then, when the user releases the scroll knob MB, the process returns to Step S101 (S109, S110).

On the other hand, if it is determined at Step S105 that the user has moved the pointer P upwards, the series of control buttons K is erased and a magnification scroll bar N of scale corresponding to the partial range J of the normal scroll bar M is displayed as shown in FIG. 3 (S106).

Furthermore, when the user moves the pointer P upwards while dragging the scroll knob NB, the scale of the magnification scroll bar N is changed to the scale Sz having increased magnification factor, as shown in FIG. 4 (S111 and S112) On the other hand, when the pointer P is moved to the left or right, it is determined whether the scroll knob NB has moved to the end position of the scroll bar N (S113, S114).

When the scroll knob NB moves to the end of the scroll bar N, the scale is changed as shown in FIG. 5 (S115). Then, a still image corresponding to the position of the scroll knob NB is displayed in the frame R (S116). When the user drops the scroll knob NB, the process returns to Step S101 (S117, S118).

Thus, in the first embodiment, when the pointer P on the scroll knob MB in the normal scroll bar M moves upward, the magnification scroll bar N is displayed. The whole of the scale of the magnification scroll bar N corresponds to the scale of the partial range J in the normal scroll bar M, and the scroll bar N is graduated in accordance with the scale J. A still image is displayed within the frame R and is scrolled, i.e., changed in accordance with the movement of the scroll knob NB.

In the magnification scroll bar N, the scroll knob NB can be moved within a scale having the magnification factor ten times that of the normal scroll bar M. Namely, a length of a scale unit in the magnification scroll bar N is ten times that of the scale in the normal scroll bar M. Consequently, the scrolling of a still image can be adjusted finely by using the magnification scroll bar N, whereas the scroll can be adjusted largely by using the normal scroll bar M. The user can scroll images with excellent user interface.

The length of the magnification scroll bar N may be set to a given length different from that of the normal scroll bar M, and the value of the magnification factor may be optionally set. The pause of a movie and the display of a still image may be performed by only clicking the scroll knob.

As shown in FIG. 5, the scale may change when the scroll knob moves to a position corresponding to a predetermined time. Furthermore, the last magnification factor used before the display of the magnification scroll bar, may be recorded, and the recorded value may be used as the initial value in the subsequent display of the magnification scroll bar.

The scroll of the magnification scroll bar may be performed by optional operation, e.g., an operation of a mouse wheel, or a keyboard. Also, the magnification scroll bar may be displayed by an operation other than dragging.

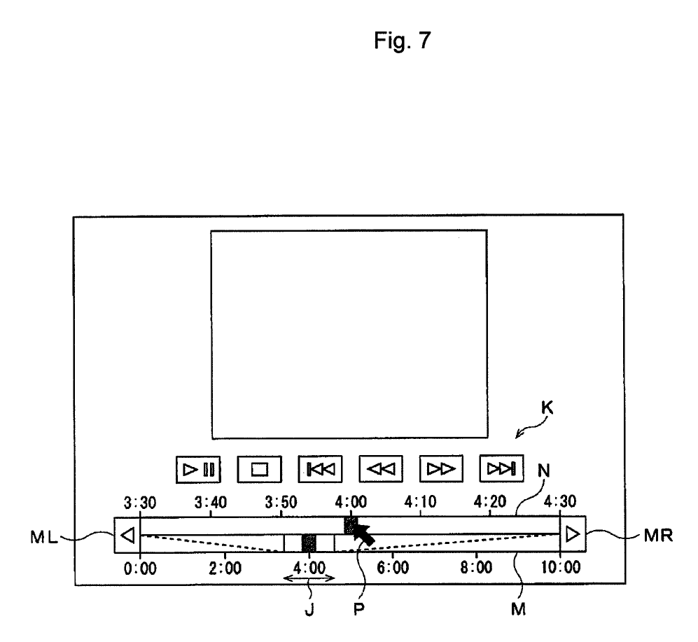

Next, the second embodiment is explained with reference to FIG. 7. The second embodiment is different from the first embodiment in that a series of scroll buttons is commonly used. Other constructions are substantially the same as those of the first embodiment.

FIG. 7 illustrates a screen displaying a scroll bar according to the second embodiment. When a given operation (e.g., depression of a function key) is performed, the magnification scroll bar N is displayed beside the normal scroll bar M as shown in FIG. 7. The right and left buttons MR and ML are common buttons in the normal and magnification scroll bars M and N. The series of control buttons K is always displayed. With the performance of a following operation, only the normal scroll bar is left to remain.

Note that the partial range J of the normal scroll bar M and the magnification scroll bar N may be displayed in a common color to clarify the corresponding relationship between the normal scroll bar and the magnification scroll bar.

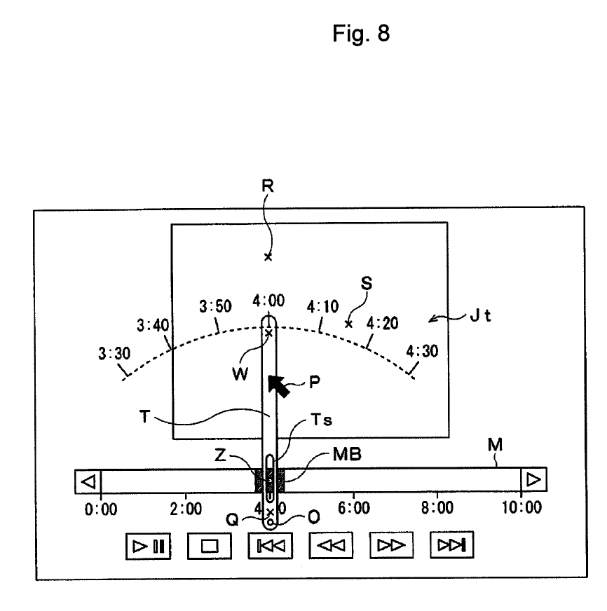

The third embodiment is explained with reference to FIG. 8. The third embodiment is different from the first embodiment in that a pivotable scroll bar is displayed and the amount of scroll is adjusted by a rotational movement of the scroll bar instead of a horizontal movement of the scroll knob. Other constructions are substantially the same as those of the first embodiment.

FIG. 8 illustrates a screen displaying a scroll bar according to the third embodiment.

When a given operation (e.g., depression of a function key) is performed, a magnification scroll bar T is displayed in a direction perpendicular to the normal scroll bar M. The magnification scroll bar T pivots around a pivot axis “O” when the magnification scroll bar T is dragged, and a point (hereinafter, called an “action point”) Z is displayed in the scroll knob MB. The action point Z moves in accordance with the pivot of the magnification scroll bar T. The magnification scroll bar T is erased when any other operation is performed.

The action point Z is within a hole mark Ts displayed within the magnification scroll bar T. When the display position of the hole mark Ts varies with the pivot of the magnification scroll bar T, the display position of the action point Z varies with the displacement of the hole mark Ts. The scroll knob MB shifts with the movement of the action point Z.

The magnification scroll bar T has a scale Jt graduated in arc, and graduations are displayed along a trace of the tip portion of the magnification scroll bar T. The scale Jt corresponds to the partial range of the normal scroll bar MB, as in the first embodiment.

The magnification scroll bar T mimics the operation of a lever. Namely, the magnification scroll bar T acts like a lever with a hole in same relative position as the hole mark Ts, and a pin analogous to the action point Z, and the relative movement of the action point Z is similar to the relative movement of the pin when the lever pivots.

And thus, the distance of the magnification scroll bar T to be moved or rotated in a time unit lengthens, as an input operation (e.g., clicking) is performed farther from the pivot axis O. Thus, the user can adjust the amount of scroll finely by dragging the magnification scroll bar T at the tip portion of the magnification scroll bar T.

For example, when the user drags the magnification scroll bar T from the point W, far from the pivot, and moves the magnification scroll bar T in an arc over a given distance, the magnification scroll bar T pivots slightly so that the time point changes finely. On the other hand, when the user drags the magnification scroll bar T from the point Q, close to the pivot axis O and moves the magnification scroll bar T by the same distance, the magnification scroll bar T rotates greatly. Thus, the user can adjust the amount of scroll finely and dynamically.

The position of the pivot axis “O” may also be adjusted within the magnification scroll bar T. Also, the length of the magnification scroll bar T may optionally be adjusted. For example, the magnification scroll bar T may elongate to the point R shown in FIG. 8 by clicking the point R.

Furthermore, the magnification scroll bar T may be made to rotate when a point off of the magnification scroll bar T is clicked. For example, the magnification scroll bar T may move to point S when point S is clicked.

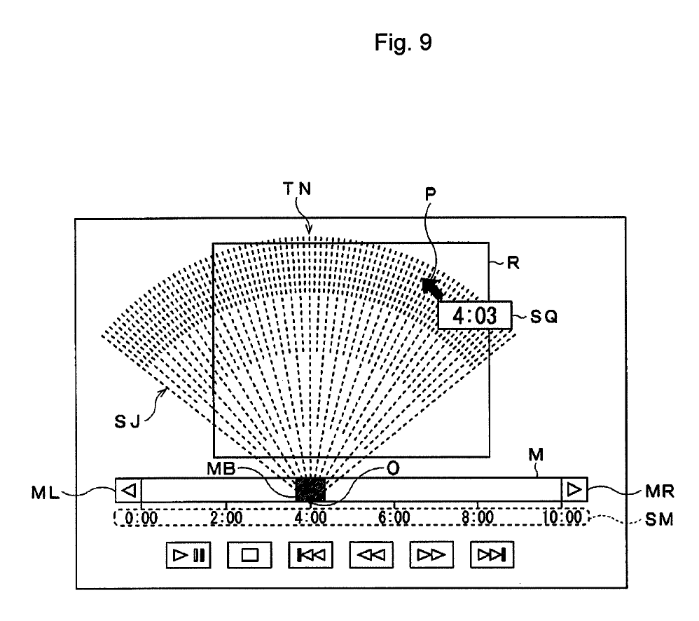

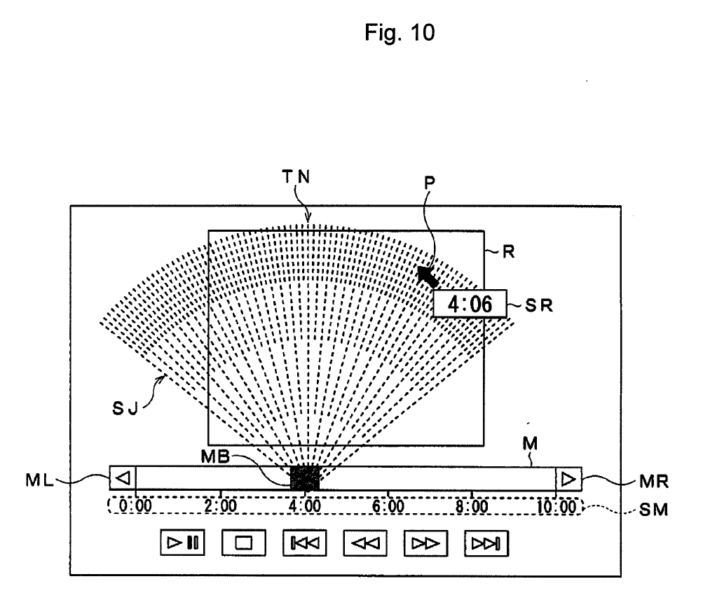

The fourth embodiment is explained with reference to FIGS. 9 and 10. The fourth embodiment is different from the first embodiment in that a scale is radially displayed. Other constructions are substantially the same as those of the first embodiment.

FIG. 9 illustrates a display with a scroll bar according to the fourth embodiment. When a given operation (e.g., a function key operation) is performed when the normal scroll bar is displayed, the screen switches to a display of a scale as shown in FIG. 9.

A sector-shaped scale SJ is represented by a series of broken lines that extend radially from a center position “O”, and functions as an indicator. A time corresponding to any given point in each broken line is defined on the basis of the distance from the center point “O”. A circumferential interval of broken lines represents a scale interval as in the third embodiment. The broken line TN at the center of the broken lines SJ, perpendicular to the normal scroll bar M corresponds to a reference time which the scroll knob MB designates (in FIG. 9, the time “4:00”), and the broken lines spaced outwardly from the broken line TN represent more distant time intervals from the standard time.

When the user clicks the mouse with pointer P being indicating a given point, the amount of scroll, namely, a time to be moved is obtained by following formula: i.e.

T=t0+M×arctan((x−x0)/(y−y0)) (1)

Note that “t0” represents the standard time that the scroll knob MB indicates, (x0, y0) represents the coordinates of the center point “O” of the scale SJ;, (x, y) represents the coordinates of the position that pointer P indicates, and M represents the magnification factor (here, 10).

If the time indicated by the pointer P is a desired time, the user may click the mouse 35. For example, when the pointer indicates a broken line exhibiting a time “4:03”, explicit time information (e.g., “4:03”) is displayed as shown in FIG. 9. If the time “4:03” is a desired time, the user may click the mouse 35. An amount of scroll is calculated with formula (1) and a still image at that time point is presented. At the same time, the scroll knob MB moves in accordance with the newly calculated time, and the center point “O” of the scale SJ also moves. Namely, the display position of the scale SJ totally shifts rightward or leftward in accordance with the movement of the scroll knob MB.

Note that, as can be seen from the formula (1), scrolling may occur even if the pointer P is not pointing directly to a broken line, and explicit information corresponding to the indicated position will still be displayed.

FIG. 10 illustrates a display of the scale-changed scroll bar. The scale SJ, represented by the broken lines, is changed to a scale having a reference time that was newly set by a click operation. Herein, the broken line TN corresponds to the time “4:03”. When the pointer P is located at a point shown in FIG. 10, an amount of scroll is calculated with the formula (1) and the time (e.g., “4:06”) is displayed. The user may click the mouse 35 to stop at time “4:06” if desired.

In the above embodiments, graduations are displayed along the first and second scroll bar. However, the graduations could also be omitted. Also, the displayed scroll bar might have right and left buttons but not a scroll knob. In that case, the user may adjust the scroll amount using the right and left buttons.

The display process described above for displaying a scroll bar on a screen may be applied in different software, such as word processors, and spread sheet applications. In that case, the type of graduations is determined in accordance with the type of software. Moreover, the display process may be applied to another video/computer system (e.g., an endoscope system), or electric equipment such as mobile equipment with a display function (e.g., PDA, digital camera, or mobile phone).

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2008-121090 (filed on May 7, 2008), which is expressly incorporated herein by reference, in its entirety.

1. A graphic system comprising:
a first display processor that displays a first scroll bar that comprises a first scroll knob and comprises a scale associated with information displayed on a screen;
a scroll controller that scrolls the information in accordance with the movement of the first scroll knob; and
a second display processor that displays the partial range that comprises a display area of the first scroll bar as a second scroll bar when a given operation is carried out during the display of the first scroll bar;
said second display processor setting the scale of the second scroll bar to the scale of the partial range, said scroll controller scrolling the information in accordance with an operation performed on the second scroll bar.

2. The graphic system of claim 1, wherein said second display processor displays the second scroll bar such that it is longer on the screen than the partial range.

3. The graphic system of claim 1, wherein the first and second scroll bars are displayed simultaneously.

4. The graphic system of claim 1, wherein said first display processor shifts a position of the first scroll knob in accordance with a scroll performed to the second scroll bar.

5. The graphic system of claim 1, wherein said second display processor displays a second scroll knob in the second scroll bar, said scroll controller scrolling the information in accordance with the movement of the second scroll knob.

6. The graphic system of claim 5, wherein said second display processor changes the scale of the second scroll bar in accordance with an operation performed on the second scroll bar.

7. The graphic system of claim 6, wherein said second display processor changes the scale of the second scroll bar when an operation is performed on the second scroll knob along a direction perpendicular to the longitudinal direction of the second scroll.

8. The graphic system of clam 1, wherein said second display processor pivots the second scroll bar in accordance with a given operation, said scroll controller scrolling the information according to the distance between the pivot axis and the operation position.

9. The graphic system of claim 1, wherein said second display processor displays a radial indicator that comprises a series of lines extending radially and has graduations corresponding to a distance from its center point to the ends of the lines.

10. The graphic system of claim 1, wherein said first display processor displays graduations in accordance with the scale of the first scroll bar.

11. The graphic system of claim 1, wherein said second display processor displays graduations in accordance with the scale of the second scroll bar.

12. The graphic system of claim 1, wherein a motion picture is displayed while the first scroll bar is displayed, and a still image is displayed when the second scroll bar is displayed.

13. An apparatus for controlling the display of a scroll bar, comprising:
a display processor that displays a second scroll bar when an input operation is performed while a first scroll bar of a scale associated with information displayed on a screen, said display processor displaying the second scroll bar such that it is longer on the screen than the first scroll bar; and
a scale controller that sets the scale of the second scroll bar to the scale of a partial range of the first scroll bar.

14. A computer-readable medium that stores a program for controlling a display of a scroll bar, comprising:
a display process code segment that displays a second scroll bar when an input operation is performed while a first scroll bar of a scale associated with the information displayed on a screen, said display process code segment displaying the second scroll such that it is longer than the first scroll bar; and
a scale control code segment that sets the scale of the second scroll bar to the scale of a partial range of the first scroll bar.

15. A method for controlling the display of a scroll bar, comprising:
displaying a second scroll bar when an input operation is performed while a first scroll bar that comprises a scale associated with the information displayed on a screen is displayed;
displaying the second scroll bar so as to be longer than the first scroll bar; and
setting the scale of the second scroll bar as the scale of a partial range of the first scroll bar.
